(19) United States
(12) Patent Application Publication
(10) Pub. No.: US 2005/0253561 A1
(43) Pub. Date: Nov. 17, 2005

(54) Temperature sensitive charging of batteries with simple chargers

(76) Inventor: Bobby Leon Tibbs, Gainesville, FL (US)

Correspondence Address: SVEN W. HANSON, PO BOX 357429, GAINSVILLE, FL, 32635-7429, US

(21) Appl. No.: 10/842,974

(22) Filed: May 11, 2004

(51) Int. Cl. H02J 7/04

(52) U.S. Cl. 320/150

(57) ABSTRACT

Methods and devices are provided for charging a battery in a temperature controlled charging process using a simple voltage-controlled charger. A control circuit includes elements for increasing the apparent voltage drop in a charging circuit, including a rechargeable battery, to produce a signal to a connected voltage-controlled charger to effect a lowering of the charger supplied charging current. This increased voltage drop is initiated upon sensing battery temperatures at or above a predetermined limit. In this way, a solely voltage-controlled charger may be controlled by battery temperature.

### BACKGROUND OF THE INVENTION

The present invention pertains to rechargeable electrochemical cells and batteries and methods and devices for charging them.

For many years, high current and high energy electric power demands in mobile powered devices have been generally met by primary and secondary (rechargeable) cells and batteries using relatively simple chemistries. A “simple” chemistry battery is herein meant to indicate a battery which is largely temperature independent in operation and is ordinarily charged and discharged without consideration of physical or chemical parameters beyond voltage and current. Examples of widely used “simple” batteries are typical lead-acid batteries (SLB) used in automobiles for energizing an engine starter. Most SLB are charged using a process in which charging current is governed solely by battery voltage. For this reason, they are provided with only two electrical contacts. For example, in one example typical SLB charging process, the charging current is maintained constant until a threshold—fully charged—voltage in the battery is reached, at which point the charging current is reduced to zero or to a minimum maintaining charging current. In a variation process, the charging current is inversely proportional to the battery voltage: the charging current is actively reduced as the battery gains charge and battery voltage rises. Other variations on these methods are also used, but in any case the only control parameter that need be used to control charging in simple battery designs such as SLB is the battery voltage. Generally, when the battery voltage reaches a max limit, the battery can be presumed to be substantially fully charged.

With the ongoing surge in consumer electronics products, battery designs have evolved to provide performance capabilities not provided by SLB. To meet the increased capabilities sought, these new batteries use more sophisticated chemistries, including those generally known in the industry as nickel cadmium (NiCd), nickel metal hydride (NiMH) and lithium ion (Li Ion). Due to the different chemistries in these “modern” rechargeable cells batteries, their respective charging processes are more complex than those required with SLB. In particular, charging processes in modern batteries are generally accompanied with significant heat production within the cell to the extent that cell temperatures must be monitored continuously. For use with most modem batteries, chargers must be designed to detect thermal changes so that the charger will reduce or stop charging before elevated temperatures cause damage to the battery. Typically, this is accomplished by constructing the battery with a temperature sensing element attached on or within a battery assembly. The temperature data or signal is used in circuit elements to control the charging process. For this purpose, chargers designed for temperature controlled charging are provided with electrical connections in addition to the two required to transmit the charge current—at least three total. Chargers for these cells typically are controlled by complex algorithms considering cell temperature, temperature change rate, voltage, and charge current to safely enable the charging process. Thermal effects are most critical when rapid charging is required.

During continuous rapid charging with many modem batteries, a “breakdown” temperature is often reached in the battery before the desired battery full-charge voltage is obtained. At this temperature, the battery voltage actually drops with increasing charge. This phenomenon is due to the effect of temperature on the chemistry of the battery and its charging process and is well known. Because the full-charge voltage would never be reached, after the breakdown temperature is exceeded when charging is by a simple voltage-controlled charger, the rapid charging rate would be maintained or increased by the charger. As a consequence, battery temperatures would further increase with continued charging without the design voltage limit ever being reached. The eventual result is likely to be thermal run-away and severe damage to the battery. For this reason, chargers that are insensitive to temperature are not generally used to charge modern batteries. When charging can be accomplished over an extended time at relatively low rate, temperature is less a factor due to the inherent greater ability to dissipate heat over time.

As a consequence of the long history of use of SLB, chargers providing simple voltage dependent charging processes are inexpensive and widely available. Unfortunately, due to their inherent simplicity and lack of temperature control, they are of little practical use in filling the need for recharging of modem batteries, particularly when rapid charging is desired

Rechargeable batteries are replacing other energy sources in portable high energy demanding powered devices. For example, battery powered bicycles, vacuum cleaners, automobiles, and lawn mowers are becoming more widely used and available. The open environments in which these powered devices are used makes the availability of recharging capacity more of a necessity, and the lack thereof more of a problem. This is exacerbated by the desire for short recharge times—rapid charging at high currents. SLB chargers are available, but largely unusable to fill this need. What is needed is a means of using simple two-contact chargers to safely and rapidly charge modem temperature dependent rechargeable batteries such as those exemplified by NiMH, NiCd, and Li Ion batteries.

### SUMMARY OF THE INVENTION

The present invention provides methods and devices for charging a battery in a temperature controlled charging process using a simple voltage-controlled charger. In the inventive devices, a control circuit includes elements for increasing the apparent voltage across a charging circuit, including a rechargeable battery, to produce a voltage signal to a connected voltage-controlled charger to activate a lowering of the charger-supplied charging current. The increased voltage is initiated upon sensing battery temperatures at or above a predetermined limit. In this way, a solely voltage-controlled charger may be controlled by battery temperature.

In various embodiments of the invention, a control circuit according to the invention includes a thermostat that provides a charging circuit when closed, and an incremental resistance device parallel to the thermostat. The incremental resistance device adds a predetermined voltage drop to the control circuit when the thermostat is in an open position. These components are electrically connected between a charger and one or more rechargeable batteries. An example incremental resistance device is one or more diodes. Preferably, the thermostat is of a manually resettable design. A second distinct discharge circuit may also be provided. The inventive control circuit may be connected to either the positive or negative pole of a battery with appropriate orientation of the voltage and current control components. The respective poles may be poles of cell groups of a battery with multiple voltage take-off contacts.

The present invention includes battery packs incorporating circuit elements enabling the inventive methods of charging. The present invention also includes powered devices, such as, but not limited to: battery powered bicycles, other vehicles, vacuum cleaners, automobiles, and lawn mowers, that include rechargeable batteries and circuit elements enabling the inventive methods of charging.

The present invention provides a simple and inexpensive device and method to allow charging of complex temperature dependent batteries by simple “dumb” battery chargers. The inventive device may be incorporated into new battery packs, retrofitted to existing batteries, and integrated into powered devices to allow use of existing, simple, two-contact chargers without alteration of the chargers. Additional novel characteristics and benefits of the invention are illustrated by the following exemplary embodiments.

### DESCRIPTION OF THE DRAWINGS

FIG. 1 is a schematic illustration of one embodiment of the invention including a rechargeable battery and the functional elements of control circuit for charging by a temperature insensitive battery charger.

FIG. 2 is a graph of a NiMH battery's parameters as a function of time during charging using a SLB charger and the inventive device and method.

FIG. 3 depicts an alternative embodiment of the invention.

FIG. 4 depicts a further alternative embodiment.

FIG. 5 depicts an embodiment of the invention including particular components.

FIG. 6 depicts a preferred embodiment of the invention including a manually resettable thermostat.

FIG. 7 depicts an alternative control circuit configuration with the operational elements connected to the negative pole of a battery.

FIG. 8 depicts a powered device including a rechargeable battery according to the current invention.

### DESCRIPTION OF THE PREFERRED EMBODIMENTS

In the following exemplary embodiments, elements are provided for increasing the apparent voltage across a circuit that includes a rechargeable battery to produce a signal to a voltage-controlled charger to effect a lowering of the charger supplied charging current. The increased voltage is triggered by detected battery temperatures at or above a predetermined limit. In this way, a solely voltage-controlled charger may be controlled by battery temperature. Herein, the term “battery” is intended to mean one or more electrochemical cells connected or connectable in a fashion to provide an electrical energy source. Herein, the term “voltage drop” is used relative to a charging current path and an associated connected battery during a charging process. During charging, current is forced against the battery potential; therefore any voltage drop or reduction produced by any other circuit element is additive to the voltage across the connected battery being charged.

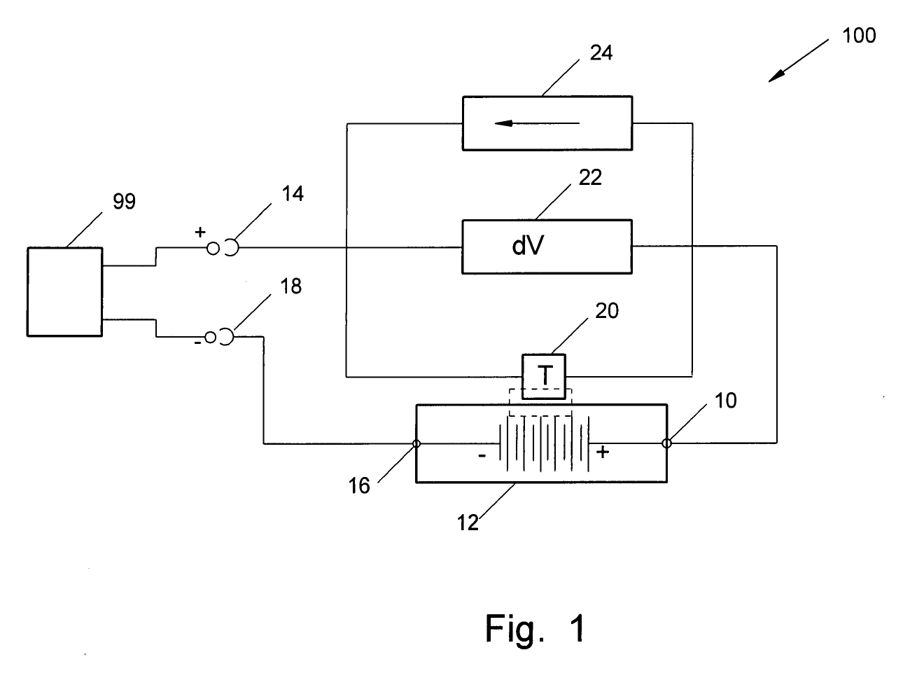

FIG. 1 is a schematic drawing of one embodiment of the invention in which a control circuit 100 is connected between a positive pole 10 of a battery 12 and a first contact 14. The negative pole 16 of the battery 12 is connected to a second contact 18. The contacts 14, 18 are required only for convenience of access and ease of electrical connection to the battery and control circuit, respectively. A typical prior art SLB charger 99 is shown connectable to the contacts 14 and 18.

The control circuit 100 includes a thermostat 20 that is in thermal communication with the battery 12 such that the thermostat will respond to the thermal condition of the battery 12 in an accurate manner. The thermostat 20 is in physical contact with any battery protective case, or otherwise in close thermal contact with the battery individual cells or cell electrodes. The thermostat 20 is electrically connected between the first contact 14 and the battery positive pole 10. The thermostat 20 has a normally closed condition below a set point temperature such that below the set point temperature there is a closed circuit allowing unimpeded current flow between the first contact 14 and the positive pole 10. Above the set point temperature, the thermostat 20 has an open condition preventing current flow through the circuit portion including the thermostat 20.

The function of the thermostat 20 is to prevent the battery from being exposed to damaging high temperatures that may result from rapid charging. It achieves this by interrupting the charging current by opening the charging circuit. Preferably, the thermostat set point temperature is selected to prevent battery temperatures from exceeding the particular associated battery's breakdown temperature. The breakdown temperature herein is considered to be the elevated temperature, above normal ambient temperatures, at which cell operation is damaged by temperature effects on the cell electrochemical components. The breakdown temperature is dependent on the particular battery design and chemistry and is generally known for most batteries, and may be easily experimentally determined for new cell designs. Battery breakdown, or temperature damage, does not occur entirely at a singular temperature. Rather, breakdown begins to occur and accelerates through a temperature range and increases with increasing temperature. The thermostat set point temperature selected for a particular application, as limiting of cell damage, may vary somewhat depending upon the balancing needs of rapid charging and cell life.

The thermostat 20 may be, alternatively, selected or configured to automatically reset when the temperature drops below the set point temperature, or for manual resetting. For NiMH and many other batteries, the thermostat set point is preferably in the range of 40 to 60 degrees C and most preferably about 45 degrees C. A lower temperature set point will increase charging time unnecessarily or result in incomplete charging. Higher set point temperatures run too great a risk of battery damage for most batteries considered here.

When a NiMH battery is charged using a typical SLB charger and the inventive device, it is likely that the battery temperature will rise such that the thermostat 20 will open at the set point temperature while the battery 12 is only partially charged. In the system of FIG. 1, the control circuit 100 includes a circuit path including an incremental resistance device 22 that allows continued charging at reduced current after the thermostat has opened. To enable this mode of charging, the SLB charger 99 is presumed to provide for charging at reduced charge current at higher voltages.

In order to induce the voltage controlled SLB charger to reduce charge current, it must be signaled by providing an apparent elevated voltage across its charging contacts. This is accomplished by means of the incremental resistance device 22. When the thermostat 20 is opened, the total voltage apparent to the charger 99 is the combination of that of the incremental resistance device 22 and the battery 12. The specific voltage drop across the incremental resistance device 22 is designed to ensure that the combined voltage is at least a value that will induce an acceptable reduced current to be delivered from the charger. In cases using what is commonly known as regulated chargers having a defined voltage limit CP beyond which the charging current is greatly reduced, the combined voltage must be designed to be above that voltage limit CP. The incremental resistance device 22 may use any of a variety of components to provide the needed function. These include, for example, but are not limited to: diodes, thermistor, transistors and relays and combinations and known functional equivalents thereof. Most preferably, the incremental resistance device 22 is formed of a series of diodes connected between battery and the charger as is discussed below.

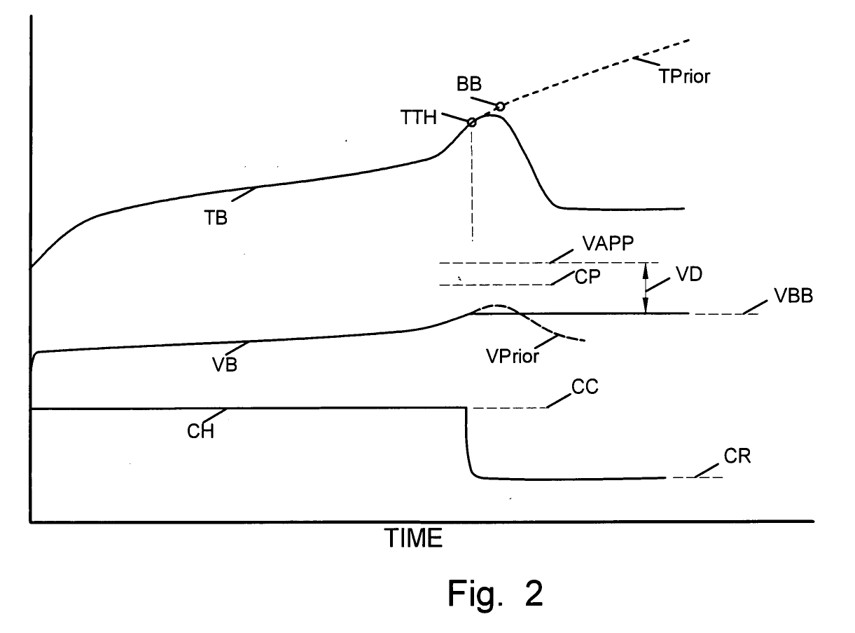

The specific voltage drop required to be provided by the incremental resistance device 22 is defined by the battery voltage present at the time the thermostat opens and the voltage limit CP that signals the specific charger to reduce the supplied charging current. The battery voltage may be approximated by reference to the battery voltage at breakdown. This, and the selection of proper design of the incremental resistance device 22, are discussed in the following with reference to FIG. 2.

FIG. 2 depicts a charging process, according to the present invention, of a typical temperature sensitive battery using a charger that is only voltage controlled. The figure includes simultaneous plots, versus time, of battery temperature TB, battery voltage VB, and charging current CH provided by a connected SLB charger responding to the apparent battery voltage, including a control circuit configured and operated in the manner of the embodiment of FIG. 1. The individual plots are not to scale and depict relative values on a common time line. A charger is presumed to provide constant charging current to the battery until an apparent voltage limit CP is reached, at which point the charging current is reduced to a lower maintenance level CR. The initial condition of the battery is fully discharged at surrounding ambient temperatures in the range of 20 to 30 degrees C. At initial charging at the start time, the voltage apparent to the charger is the relatively low battery voltage—below the charger switching limit voltage CP. A relatively high charging current CC for rapid charging is applied to the battery with an immediate resulting temperature rise. With continued charging, the temperature and battery voltage rise with the charge state of the battery as shown.

Due to the increased battery voltage and high charge current, the temperature continues to rise and would reach a breakdown point BB if the present control circuit did not interrupt the charging current. Below the breakdown point BB, the high temperature arid consequent battery chemistry degradation would result in a battery voltage reduction despite increasing charge. Because of this voltage reduction, the charger limit voltage CP would not be reached to signal the charger to reduce the charge current. The voltage and temperature paths to and through the breakdown point BB is shown as dashed plot lines VPRIOR and TPRIOR, respectively, and represent a phenomenon known in the prior art.

With the inventive device, before damaging temperatures at the breakdown point BB are reached, the thermostat set point temperature is reached and the thermostat opens to interrupt the instant relatively high charge current. Preferably, the thermostat set point is designed to open the thermostat at a threshold temperature TTH slightly below the breakdown point BB. This is because, due to thermal transients and delay, the battery temperature TB may continue to briefly rise after the high charge current is interrupted. Due to any thermal gradients between the battery and the thermostat, the set point temperature may need to be slightly lower than the battery threshold temperature TTH. In any case, the thermostat set point should be lower than the breakdown point temperature. In the figure, the thermostat is presumed to open at the threshold temperature TTH.

When the thermostat opens, the apparent battery voltage VAPP seen by the charger includes both the battery voltage and that of the incremental resistance device—VD. The apparent voltage VAPP must be at, or exceed (depending on charger design), the charger limit voltage CP to ensure signaling the charger to reduce the charging current. The charge rate is then actively lowered by the charger's known design configuration to the reduced charging current CR. Due to this reduced charge rate, heat generation within the battery is reduced and temperatures are allowed to drop due to natural or induced heat dissipation to the battery's surroundings.

Design or selection of the incremental resistance device and its voltage drop VD depends upon the actual expected battery voltage at the time the thermostat opens. This voltage may be unknown but can be closely approximated by the known specific battery voltage at breakdown if the thermostat set point is close to the breakdown temperature. To insure the limit voltage CP is reached, the incremental resistance device voltage drop must be at least:
VD=CP−VBB
where VBB is the battery voltage at the moment the thermostat opens, which is presumed to be the breakdown voltage of the battery. VD can vary somewhat from this calculated value, but if the voltage drop provided is too small, the limit voltage CP will not be reached as a signal to the charger.

As well, the voltage drop provided must not be too great, or the voltage applied to the battery after the thermostat opens will be insufficient to enable continued effective charging of the battery, and only a partial charge will result. As well, if the voltage drop VD is too large, the circuit including the battery will appear to be open and may induce the charger to cease providing charging current, resulting in an undesirable partial charge.

The range of battery breakdown voltage is known for most modern battery designs. For many NiMH and NiCd batteries, the battery voltage at breakdown is known to be in the range of 1.43 to 1.55 volts per cell at ambient temperatures in the range of about 20 to 30 degrees C. This is somewhat dependent upon chemistry and the preceding rate of temperature rise. If the battery voltage at breakdown is not known, the maximum VD needed may be less preferably determined from the no-load battery voltage when fully discharged. For NiMH and NiCd batteries the no-load fully discharged voltage is approximately 1.2 volts per cell; and for Li Ion batteries, 3.6 volts per cell.

In the following Table of Examples, various NiMH battery configurations are combined with typical charger device voltage limits to demonstrate practical minimum incremental resistance device requirements. In the table, the total voltage drop—VD—needed is determined from the equation provided above. The charger voltage limit, CP, is a function of the particular design of the charger and must be determined in each case. However, the VD values in the table are minimums, and for a practical control circuit design, the voltage drop may be designed to be greater than the maximum VD for a number of expected charger designs with different CP values. In this manner, a control circuit can be provided for use with a number of different chargers.

Table of Examples-Charging of NiMH Batteries

| | | | | Expected | | |
|---|---|---|---|---|---|---|
| System | volts/cell | | Breakdown | Battery | Charger | Voltage Drop VD |
| Design | discharged | # of | voltage | voltage at | Voltage | Needed for Charger |
| Voltage | (no loaad) | cells | (per cell) | Breakdown | Limit-CP | Signaling |
| 12 | 1.2 | 10 | 1.43 | 14.3 | 16 | 1.7 |
| 24 | 1.2 | 20 | 1.43 | 28.6 | 29 | 0.4 |
| 24 | 1.2 | 20 | 1.43 | 28.6 | 32 | 3.4 |
| 36 | 1.2 | 30 | 1.43 | 42.9 | 45 | 2.1 |
| 14 | 1.2 | 12 | 1.43 | 17.2 | 18 | 0.8 |
| 18 | 1.2 | 15 | 1.43 | 21.4 | 22 | 0.5 |
| 24 | 1.2 | 18 | 1.43 | 25.7 | 27 | 1.3 |
| 30 | 1.2 | 22 | 1.43 | 31.5 | 33 | 1.0 |
| 32 | 1.2 | 24 | 1.43 | 34.3 | 36 | 1.7 |
| 38 | 1.2 | 26 | 1.43 | 37.2 | 40 | 2.8 |

The resulting VD values in the table is the minimum voltage drop that must be provided by the incremental resistance device in a control circuit designed to operate with the associated battery and charger. In addition, the incremental resistance device must provide approximately the desired voltage drop over a current range at least including the expected range of the charging current. Note that in the second example of the table, the battery is expected to almost reach the charger voltage limit without additional voltage drop. Indeed, in some cases the charger voltage limit may be reached without the battery reaching the breakdown temperature. However, as the breakdown temperature and the breakdown voltage are not known with certainty, a minimum provided voltage drop of at least 1.2 volts is suggested, when the calculated VD is smaller, to ensure proper control of the charger. Without this protection against variation in battery properties, thermal runaway is still a risk. This rule is also applicable and useful in use with batteries that do not have a breakdown characteristic wherein the voltage drops with temperature, but where the batteries are susceptible to damage at high temperatures.

In the embodiment of FIG. 1, and in respect to the process of FIG. 2, if the thermostat is not reset after opening, the lowered charge rate will be maintained at lowered temperatures. If the thermostat is reset at lowered temperatures, automatically or manually, the higher charge current CC will be restarted depending also upon the charger configuration and operation design.

With many batteries, it is possible that the battery temperature rises during normal discharge operations while the battery is powering a device. With batteries such as NiMH batteries using the inventive control circuit, this may result in the thermostat opening at the set point and removing the thermostat portion of the control circuit as a discharge current path. For this reason, the control circuit 100 includes a discharge circuit 24 that enables current flow from the first pole to the first contact (discharge), and that prevents current flow in the opposite direction (charging). This function may be provided by inclusion of any of a variety of electronic component such as, for example, but not limited to: diodes, transistors and relays. In operation, during charging, the discharge circuit acts as an open circuit allowing no substantial current to pass. When the battery is connected to a device to be powered, the battery may discharge to the powered device through the discharge circuit 24, even if the thermostat is closed.

Preferably, the control circuit 100 is enclosed in a typical battery pack case or other protective envelope with the battery cell or cells. However, in alternative configurations, the same functions may be obtained with a control circuit separate from the battery with the thermostat attachable to the battery. This alternative design may be used to retrofit existing battery packs to enable the inventive modes of charging. Various temperature probes are taught in the prior art for this function and operation.

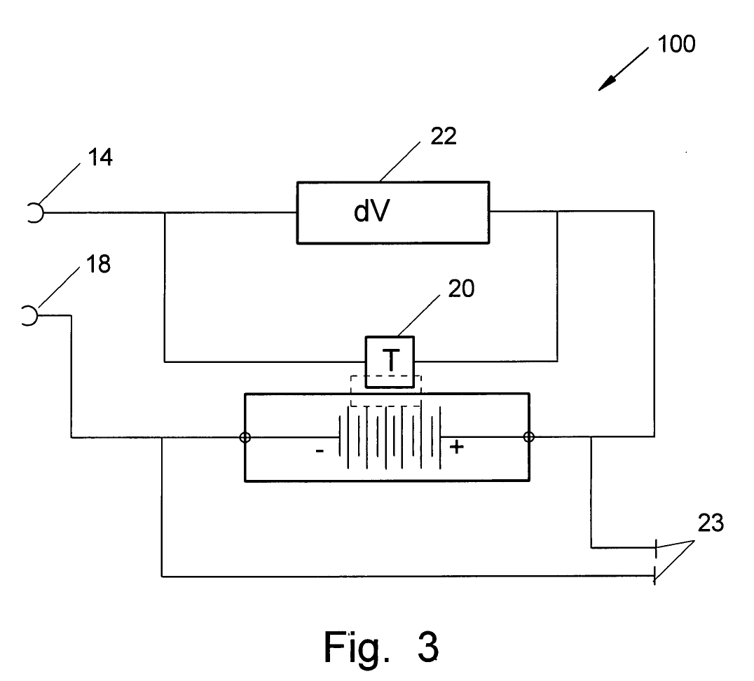

As discussed above, the control circuit may operate without a separate discharge circuit distinct from the circuit including the thermostat. This configuration may be used where discharge is assured to be unaffected by thermal events or where a separate discharge path is provide by independent circuits connected or connectable to the battery. This latter configuration is shown in FIG. 3 where a separate circuit leads to load contacts 23 used during discharge to a load.

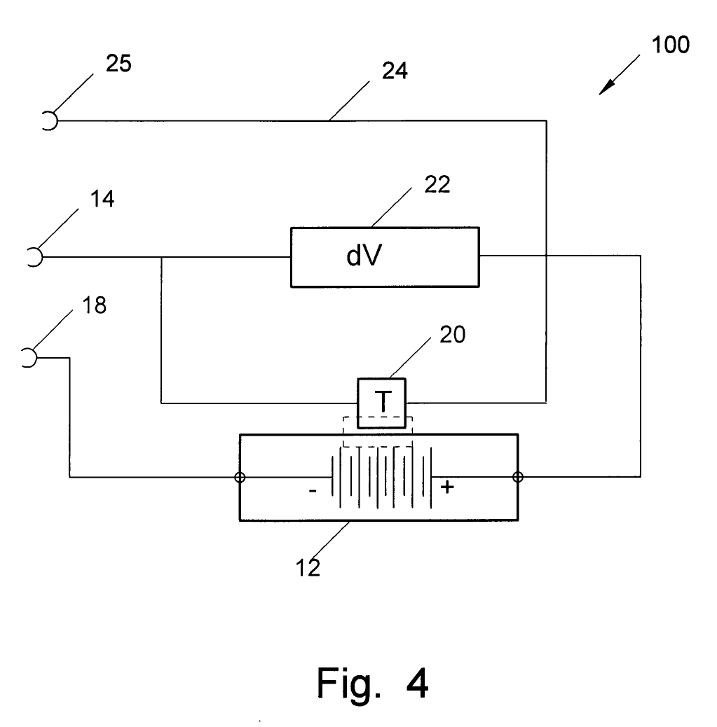

FIG. 4 depicts an alternative configuration in which the discharge circuit 24 includes a distinct discharge contact 25. In such a configuration, a device to be powered is connected to the battery, via the second contact 18 and to the discharge contact 25.

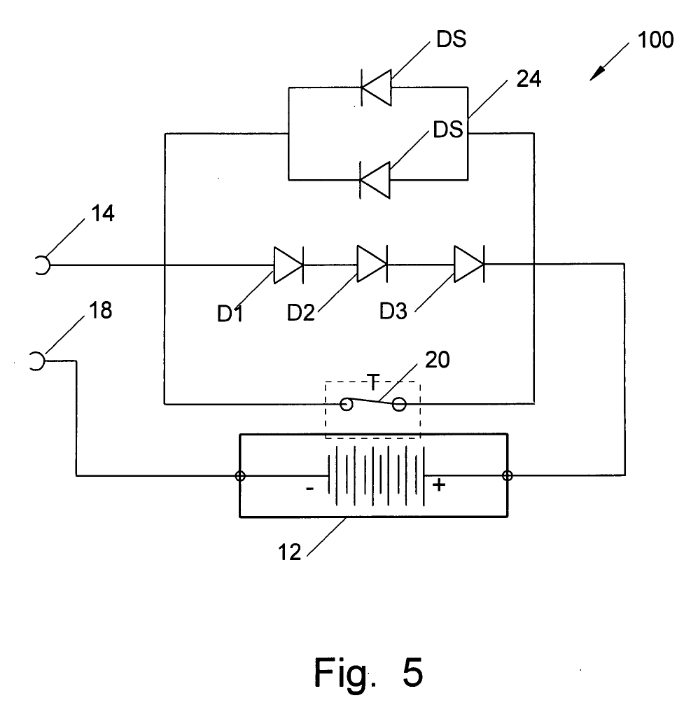

FIG. 5 is a schematic drawing of the embodiment shown in FIG. 1 wherein the functional elements are replaced with specific components. The control circuit 100 includes a incremental resistance device formed by three diodes D1, D2, D3 mutually connected in series, and connected in parallel to the thermostat 20. This configuration is used to make use of existing and readily available diodes to easily provide the proper voltage drop for a variety of practical design configurations. For a prototype device used in conjunction with a 24 volt nickel metal hydride battery to be charged by a SLB charger having a CP of 32 volts, the following components were found to work well: Schottkey diodes of type MBRD 1035CTL for 10 amperes current with V_{ARM} of 35 volt and V_{FM} of 0.2 to 0.3 volt; and for the incremental resistance device: standard diodes Type IN4001 for 1.0 ampere current with V_{ARM} 50 volts and V_{FM} of 0.6 to 1.1 volt.

In FIG. 5, the discharge circuit 24 includes two Schottkey diodes DS in mutually parallel arrangement to ensure the required directional current path. The redundant discharge paths provide greater current capacity and assurance of operation against single diode failure. However, a single, or greater number of, diodes may be used to achieve the same effect.

In any of the embodiments shown, a second thermostat or thermal fuse may also be incorporated near the battery as redundant thermal protection as also found in prior battery packs.

The second thermostat should have a set point temperature above the set point of the control circuit thermostat 20.

Optionally, a resistor or similar heating device may be connected to heat the control circuit thermostat 20 when the thermostat is first opened. This may provide a dampening of the thermal response and delay resetting of the thermostat to reduce “bouncing” between the thermostat set points.

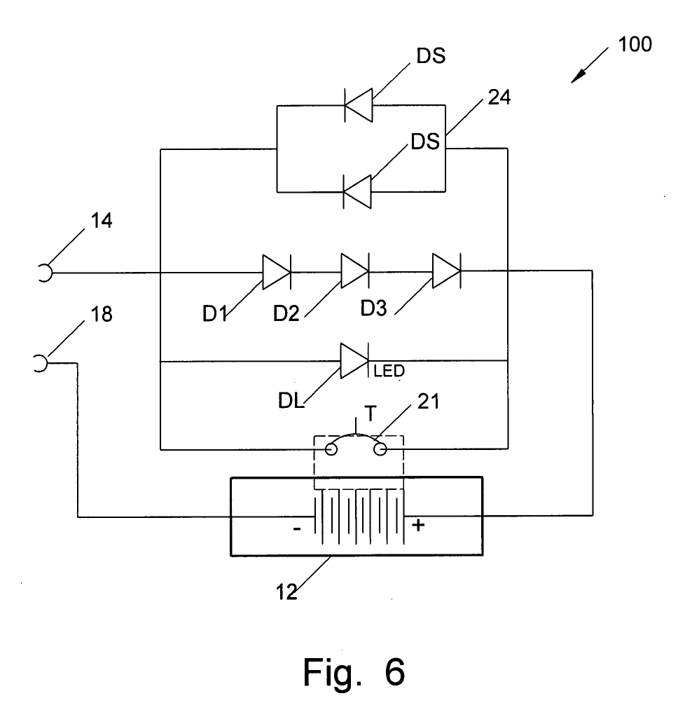

FIG. 6 is a schematic drawing of a preferred embodiment of the invention. This embodiment is similar to that of FIG. 5 except that a manually resettable thermostat 21 is provided. In addition, a LED diode is connected across the thermostat and configured to provide an illumination signal to a user in the event of the thermostat opening. In this manner, in operation the user is provided a signal of the change in charging status and prevents restarting of high current charging without active selection by the user.

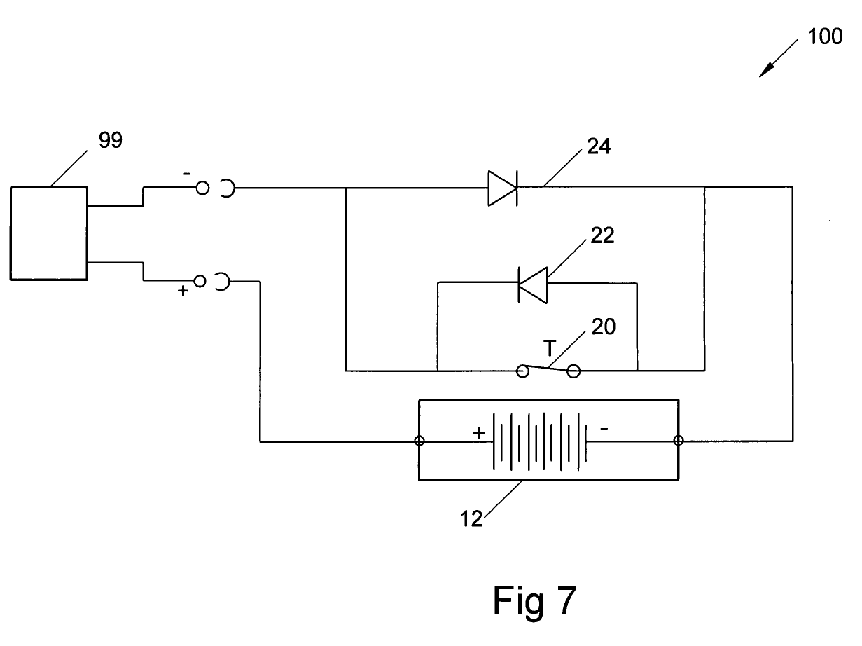

In all of the above examples, the control circuit is disclosed as connected to the positive pole of the battery. The same function of providing a temperature triggered voltage drop to signal an attached voltage-controlled charger may be provided by circuit elements connected to the negative pole of a battery. FIG. 7 depicts an equivalent configuration in which the operational elements of the control circuit are connected to the negative pole of the battery 12. Note that in all configurations depicted in the figures, the diodes are biased in the same relative directions with respect to the charging current.

Other means of introducing additional voltage drop or increasing the apparent voltage of the battery to provide an elevated voltage signal may be used to accomplish the functions of the invention. For example, a temperature probe may be used to create an electrical signal that is received by a switching device. The switching device, upon receiving an electrical signal from the probe that indicates a temperature above a threshold temperature, switches the charging circuit to include an incremental resistance device, in series or parallel, thereby increasing the apparent voltage drop to effect the same result. The switching device may include an electronic relay, solid state device, or integrated circuit device. The integrated circuit device may include logic elements that incorporate other parameters such as time to add temperature change rates to the control configuration. However, such designs add needless complexity and cost for the applications considered here.

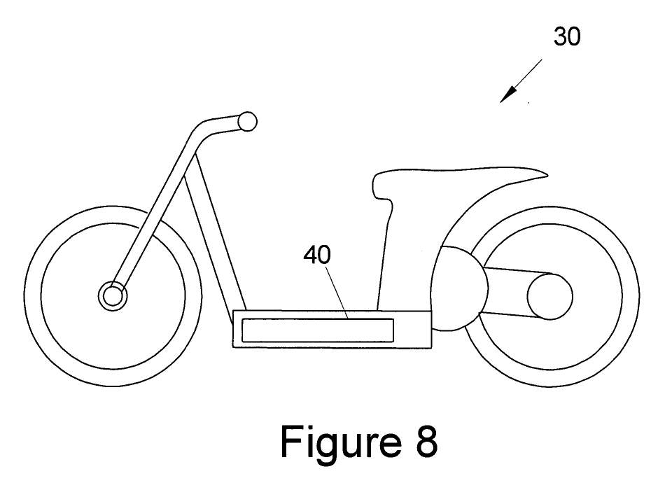

FIG. 8 depicts a rechargeable battery powered device 30 incorporating the present control circuit. The powered device shown is an electric bicycle having a battery pack 40 including a battery and control circuit as described above including NiMH cells and a control circuit for enabling charging by SLB type chargers. The battery pack may be configured to be recharged in-situ without removal from the powered device or may be first removed. The specific design of the contacts for connecting the battery pack 40 to a charger will be known to one skilled in the art.

The preceding discussion is provided for example only. Other variations of the claimed inventive concepts will be obvious to those skilled in the art. Adaptation or incorporation of alternative devices and materials, presently known and future is also contemplated. The intended scope of the invention is defmed by the following claims.

1. A rechargeable battery comprising:
at least one interconnected electrochemical cell; and
a charging control circuit connected to the cells and comprising:
means of connecting the control circuit to a charger having only two charging contacts;
means of sensing when a cell temperature exceeds a predetermined threshold temperature; and
means of increasing, by a predetermined additional voltage, a control circuit voltage between the charger contacts when the cell temperature exceeds the threshold temperature during charging.

2. The rechargeable battery according to claim 1, and wherein:
the means of increasing voltage includes:
a means of opening a first charging circuit and allowing charging to continue through a second charging circuit having the predetermined additional voltage.

3. The rechargeable battery according to claim 2, and wherein:
the control circuit further comprises a discharge circuit for discharging the cells.

4. A rechargeable battery comprising:
at least one interconnected electrochemical cell having a first and second pole;
at least a first charging contact;
a thermostat in thermal communication with at least one cell and providing a first charging circuit, between the first contact and the first pole, when the thermostat is in a closed condition, and the thermostat having an electrically open condition above a set point temperature;
an incremental resistance device providing a predetermined voltage drop between the first contact and the first pole when a charging voltage is applied and providing a second charging circuit between the first charging contact and the first pole.

5. The rechargeable battery according to claim 4, and further comprising:
a discharge circuit connected to the at least one interconnected electrochemical cell.

6. The rechargeable battery according to claim 5, and wherein:
the discharge circuit is connected to allow discharge between the first charge contact and the second pole and including a means of preventing a charging current from passing through the discharge circuit.

7. The rechargeable battery according to claim 6, and wherein:
the means of preventing a charging current comprises at least one diode.

8. The rechargeable battery according to claim 4, and wherein:
the incremental resistance device comprises at least one diode.

9. The rechargeable battery according to claim 4, and wherein:
the incremental resistance device provides voltage drop of at least 1.2 volts.

10. The rechargeable battery according to claim 4, and wherein:
the set point temperature is in a range of 40 to 60 degrees C.

11. The rechargeable battery according to claim 10, and wherein:
the set point temperature is 45 degrees C.

12. The rechargeable battery according to claim 4, and further comprising:
a resistor connected to provide heating to the thermostat in the open condition.

13. The rechargeable battery according to claim 4, and further comprising
an LED connected across the thermostat and configured to illuminate in the open condition.

14. The rechargeable battery according to claim 4, and wherein:
the thermostat is of a manually resettable design.

15. The rechargeable battery according to claim 4, and wherein:
each cell is a nickel metal hydride cell.

16. A control circuit for charging a rechargeable battery with a battery charger having only two charging contacts, the control circuit comprising
a first charging circuit configured to be connected between a battery and charger and comprising a thermostat configured to be placed in thermal communication with the battery, and the thermostat configured to open above a set point temperature;
a second charging circuit parallel to the thermostat and having an incremental resistance device.

17. The control circuit according to claim 16, and further comprising:
a discharge circuit parallel to the first charging circuit.

18. The control circuit according to claim 17, and wherein:
the discharge circuit is configured to prevent charging through the discharge circuit.

19. The control circuit according to claim 18, and wherein:
the discharge circuit includes at least one schottkey diode selected and connected to prevent charging through the discharge circuit.

20. The rechargeable battery according to claim 16, and wherein:
the set point temperature is in the range of 40 to 60 degrees C.

21. The rechargeable battery according to claim 20, and wherein:
the set point temperature is 45 degrees C.

22. A powered device including a rechargeable battery according to claim 1.

23. A powered device according to claim 22, and wherein:
the powered device comprises an electric bicycle.

24. A method of charging a battery with a battery charger that provides voltage dependent charging current, the method comprising:
connecting a battery to a battery charger with only two electrical contacts;
operating the charger to provide charging current to the battery;
when a battery temperature is above a predetermined threshold temperature, adding a predetermined voltage drop between the charger and the battery to reduce the charge current.
